(19) United States
(12) Patent Application Publication
(10) Pub. No.: US 2011/0094625 A1
(43) Pub. Date: Apr. 28, 2011

(54) Mobile Hood of Wood-Working Table Saw

(75) Inventor: MINGCAN YU, Yongkang (CN)

(73) Assignee: ZHEJIANG SHIDA TOOLS MANUFACTURE CO., LTD., Yongkang (CN)

(21) Appl. No.: 12/854,175

(22) Filed: Aug. 11, 2010

(30) Foreign Application Priority Data
Oct. 23, 2009 (CN) 200920218031.9

(51) Int. Cl. B27G 19/00

(52) U.S. Cl. 144/252.1

(57) ABSTRACT

The present invention relates to woodworking machinery field. More particularly, the present invention relates to Mobile hood of the wood-working table saw. In the present invention, the rear hood and front hood are flexibly connected to the fixing rack of the hoods respectively, and coupled by the combination of guide pin with slot. A tension spring is provided in addition to the hinged connection between the front hood and fixing rack, so that the hood can keep normal working when the saw blade forms a certain angle with the working table, ensure the hood should fall back freely upon the completion of sawing and cover the saw blade for the sake of safety. As the front end of front hood in the present invention does not need extending forward, the table in front of the saw blade can be used to place workpiece conveniently.

### CROSS REFERENCE TO THE RELATED PATENT APPLICATIONS

This patent application claims the priorities of the Chinese patent application No. 200920218031.9 filed on Oct. 23, 2009, which applications are incorporated herein by reference.

### BACKGROUND OF THE INVENTION

1. Field of the Invention

The present invention relates to woodworking machinery field. More particularly, the present invention relates to mobile hood of wood-working table saw.

2. Related Prior Art

In prior art, an individual protective plate is provided at both sides of the hood of wood-working table saw. The rear of protective plate is hinged with fixing hood. The hood extends a long reach in its front so that the workpiece can be conveniently pushed in. However, such a design causes a so large area of table to be occupied that the wood workpiece cannot be placed flat at the table in front of saw blade during sawing process. Thus only after the hood is lifted can the wood be placed flat. In addition to the inconvenience of operation, the protective plate may easily slide to the right and thus hardly be opened.

### SUMMARY OF THE INVENTION

In order to solve shortcoming of the prior art, the present invention provides a mobile hood for wood-working table saw. Such mobile hood can not only meet the requirement of safety, but also empty a rather large area in front of saw blade so that the wood workpiece can be placed flat at the table in front of saw blade, improving the convenience of operation and promoting production efficiency.

A mobile hood of wood-working table saw, comprising:

a fixing hood (1) mounted on a table saw (5);

a rack (3) integrally coupled to the fixing hood (1);

a front hood (4), with its right end pivoted with a right end of the rack (3) on an axle (37);

a rear hood (2), with its left end pivoted with a left end of the rack (3) on an axle (31);

a slot (24) provided in a right end of the rear hood (2) and a guide pin (44) provided in a left end of front hood (4), the guide pin (44) inserting in the slot (24) and being reciprocating in the slot (24). Wood workpiece transferred onto the table saw (5) will lift the front hood (4) and by means of the guide pin (44) carry the rear hood (2) to move upwards;

an arched slot (45) provided in the middle of front hood (4) and a guide pin (35) provided in a right end of the rack (3), the guide pin (35) inserting in the arched slot (45) and longitudinally reciprocating in the arched slot (45).

An arched slot (23) is provided in middle of the front hood (2) and a guide pin (33) is provided in a left end of the rack (3), the guide pin (33) inserting in the arched slot (23) and longitudinally reciprocating in the arched slot (23). The slot and guide pin limit the rotating angle of both rear hood (2) and front hood (4) and simultaneously ensure smoother flipping of both rear hood (2) and front hood (4).

A torsion spring (36) is provided on the axle (37), with one end fixed on the rack (3) and other end fixed in the groove (43) of front hood (4). Due to the torsion spring (36) is provided on an axle (37), the front hood(4) having lost support of the workpiece upon the completion of workpiece processing will force the rear hood (2) to flip down counterclockwise around an axle (37); the falling of front hood (4) will simultaneously bring the rear hood (2) to slide down clockwise around an axle (31), so that the hood will restore its state before processing and cover the saw blade (6) to avoid exposure the of saw blade (6) and improve its safety.

The front hood (4) consists of two protective plates (26, 27) on both sides of rack (3). The rear hood (2) consists of two protective plates (46, 47) on both sides of rack (3).

The protective plates (26, 27, 46, 47) are plastic plates.

The rack (3) is fixedly coupled by the combination of snap-fit (32) with the slot of fixing hood (1).

The workpiece being advanced will first lift the front hood (4). Then, the front hood (4) flips upwards clockwise around the central axle (37), and the guide pin (44) of front hood (4) carries the rear hood (2) to flip upwards counterclockwise around the articulated axle (31). As slot (23) and slot (45) are provided in the rear hood (2) and front hood (4), the corresponding guide pins (33, 35) are provided in the rack (3) so that the rear hood (2) and front hood (4) can be smoothly flipped.

In the present invention, the rear hood and front hood are flexibly connected to the fixing rack of the hoods respectively, and coupled by the combination of guide pin with slot. A tension spring is provided in addition to the hinged connection between the front hood and fixing rack, so that the hood can keep normal working when the saw blade forms a certain angle with the working table, ensure the hood should fall back freely upon the completion of sawing and cover the saw blade for the sake of safety. As the front end of front hood in the present invention does not need extending forward, the table in front of the saw blade can be used to place workpiece conveniently.

### BRIEF DESCRIPTION OF THE DRAWINGS

FIG. 1 is a schematic view of the present invention before working;

FIG. 2 is a schematic view of the present invention during working;

FIG. 3 is a schematic view of the coupling between hood rack and fixing hood;

FIG. 4 is a schematic view of the coupling between hood rack, rear hood and front hood.

### DETAIL DESCRIPTION OF THE INVENTION

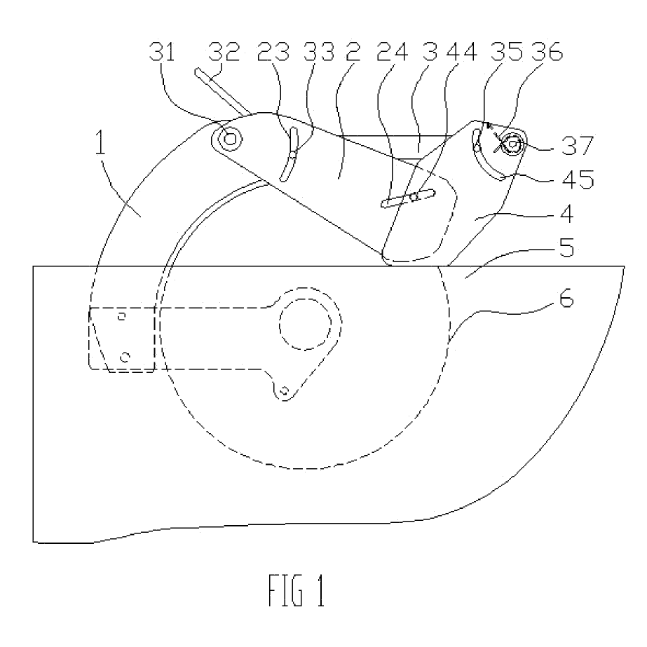

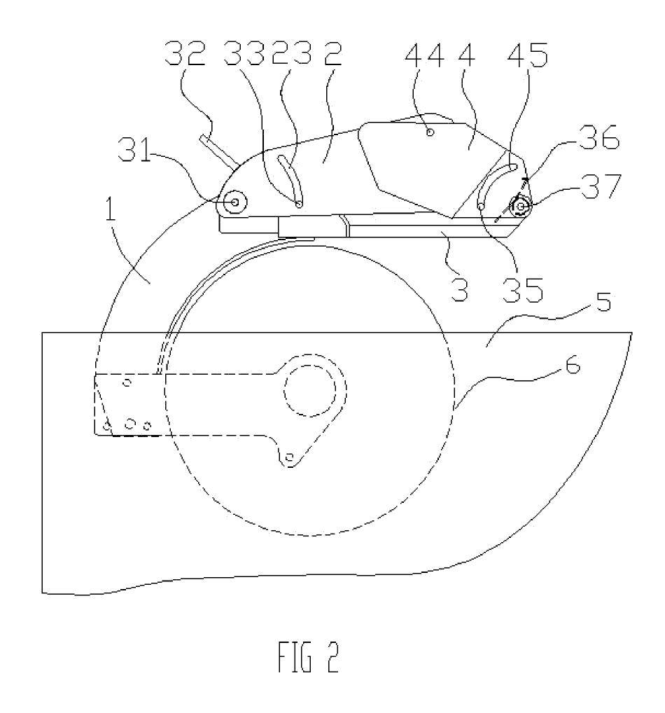

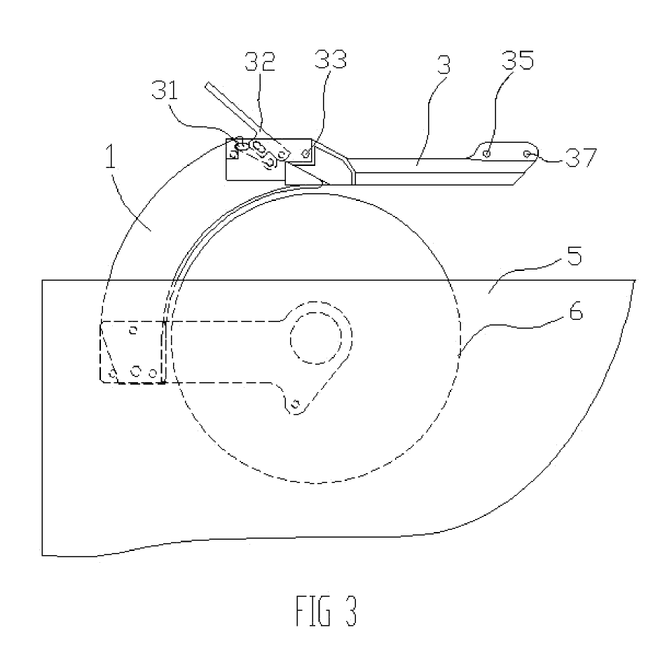

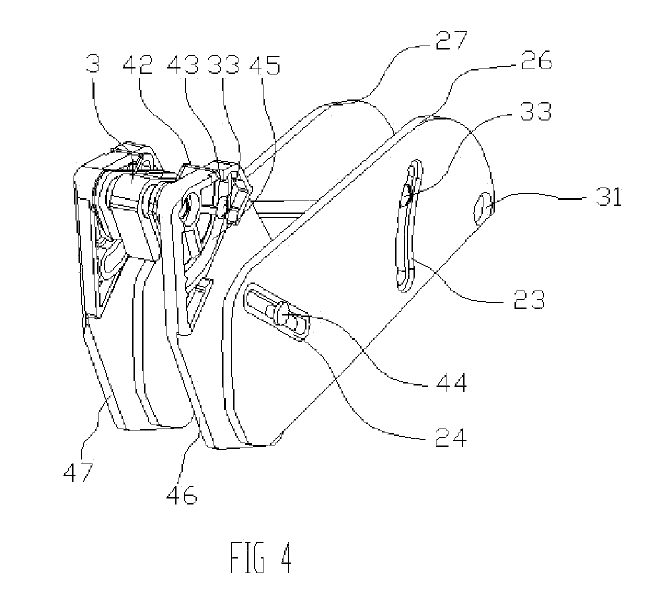

The preferred embodiment of the present invention will now be described with reference to FIGS. 1-4 of the drawings. Identical elements in the various figures are identified with the same reference numerals.

Mobile hood of the wood-working table saw, as FIGS. 1˜2 show, comprising:

a fixing hood (1) mounted on table saw (5);

a rack (3) integrally coupled to the fixing hood (1);

a front hood (4), with its right end hinged with the right end of rack (3), the front hood (4) being capable of flipping along the axle (37) hinged with the right end of rack (3);

a rear hood (2), with its left end hinged with the left end of rack (3), the rear hood (2) being capable of flipping along the axle (31) hinged with the left end of rack (3);

a slot (24) provided in the right end of rear hood (2) and a guide pin (44) provided in the left end of front hood (4), the guide pin (44) inserting in the slot (24) and traverse reciprocating in the slot (24). Wood workpiece transferred onto the table saw (5) will lift the front hood (4) and by means of the guide pin (44) carry the rear hood (2) to move upwards.

An arched slot (45) provided in the middle of front hood (4) and a guide pin (35) provided in the right end of rack (3), the guide pin (35) inserting in the arched slot (45) and longitudinally reciprocating in the arched slot (45).

An arched slot (23) provided in the middle of rear hood (2) and a guide pin (33) provided in the left end of rack (3), the guide pin (33) inserting in the arched slot (23) and longitudinally reciprocating in the arched slot (23). The slot and guide pin limit the rotating angle of both rear hood (2) and front hood (4) and simultaneously ensure smoother flipping of both rear hood (2) and front hood (4).

A torsion spring (36) provided on the axle (37), with one end fixed on the rack (3) and the other end fixed in the groove (43) of front hood (4).

The front hood (4) consists of two protective plates (26, 27) on both sides of rack (3). The rear hood (2) consists of two protective plates (46, 47) on both sides of rack (3).

The protective plates (26, 27, 46, 47) are plastic plates.

The rack (3) is connected with fixing hood fixedly coupled by a combination of snap-fit (32) with the slot of fixing hood (1).

FIGS. 1-4 show the workpiece being advanced will first lift the front hood (4). Then, the front hood (4) flips upwards clockwise around the central axle (37), and the guide pin (44) of front hood (4) carries the rear hood (2) to flip upwards counterclockwise around the articulated axle (31). As slot (23) and slot (45) are provided in the rear hood (2) and front hood (4), the corresponding guide pins (33, 35) are provided in the rack (3) so that the rear hood (2) and front hood (4) can be smoothly flipped. Due to the torsion spring (36) provided on the axle (37), the front hood (4) having lost the support of workpiece upon the completion of workpiece processing will force the rear hood (2) to flip down counterclockwise around the hinged axle (37); the falling of front hood (4) will simultaneously bring the rear hood (2) to slide down clockwise around the hinged axle (31), so that the hood will restore its state before processing and cover the saw blade (6) to avoid the exposure of saw blade (6) and improve its safety.

What is claimed is:

1. A mobile hood of wood-working table saw comprising:
a fixing hood (1) mounted on a table saw (5);
a rack (3) integrally coupled to the fixing hood (1);
a front hood (4), with its right end pivoted with a right end of the rack (3) on an axle (37);
a rear hood (2), with its left end pivoted with a left end of rack (3) on an axle (31); a slot (24) provided in a right end of the rear hood (2) and a guide pin (44) provided in a left end of front hood (4), the guide pin (44) inserting in the slot (24) and being reciprocating in the slot (24), wood workpiece transferred onto the table saw (5) will lift the front hood (4) and by means of the guide pin (44) carry the rear hood (2) to move upwards.

2. The mobile hood of wood-working table saw of claim 1, wherein an arched slot (45) is provided in middle of the front hood (4) and a guide pin (35) is provided in a right end of the rack (3), the guide pin (35) inserts in the arched slot (45) and is reciprocating in the arched slit (45).

3. The mobile hood of the wood-working table saw of claim 1, wherein an arched slit (23) provided in middle of the rear hood (2) and a guide pin (33) provided in a left end of the rack (3), the guide pin (33) inserts in the arched slit (23) and is reciprocating in the arched slit (23).

4. The mobile hood of the wood-working table saw of claim 1, wherein a torsion spring (36) is provided on the axle (37), with one end fixed on the rack (3) and other end fixed in the groove (43) of front hood (4).

5. The mobile hood of the wood-working table saw of claim 1, wherein the front hood (4) consists of two protective plates (26, 27) on both sides of the rack (3), the rear hood (2) consists of two protective plates (46, 47) on both sides of the rack (3).

6. The mobile hood of the wood-working table saw of claim 5, wherein the protective plates (26, 27, 46, 47) are plastic plates.

7. The mobile hood of the wood-working table saw of claim 1, wherein the rack (3) is connected with fixing hood (1) fixedly by a combination of snap-fit (32) with the slot of fixing hood (1).
